(19) United States
(12) Patent Application Publication
(10) Pub. No.: US 2013/0108098 A1
(43) Pub. Date: May 2, 2013

(54) PROTECTOR FOR EARPHONE CORD AND EARPHONE USING THE PROTECTOR

(71) Applicant: ZHONG-SHU QIN, Shenzhen City (CN)

(72) Inventor: ZHONG-SHU QIN, Shenzhen City (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 13/495,682

(22) Filed: Jun. 13, 2012

(30) Foreign Application Priority Data
Oct. 31, 2011 (CN) 201110337348.6

(51) Int. Cl. H04R 1/10; H01R 35/00

(52) U.S. Cl. 381/384; 439/31

(57) ABSTRACT

An earphone includes a headset plug and an earphone cord connecting to the headset plug. A protector is located around the junction of the headset plug and the earphone cord. The protector includes a fastening member secured to the headset plug, and a rotary member located around the earphone cord and assembled to the fastening member, so that the rotary member can rotate relative to the fastening member with the earphone cord when the earphone cord is bent.

### BACKGROUND

1. Technical Field

The present disclosure relates to protectors, especially to a protector for earphone cord and an earphone using the protector.

2. Description of Related Art

An earphone may include a headset plug and an earphone cord connecting to the headset plug. A plastic protector may be located around the junction of the headset plug and the earphone cord to protect the earphone cord. However, during use, the earphone cord may bend towards the plastic protector and resist against the end wall of the plastic protector, thus friction occurs between the earphone cord and the plastic protector, which is prone to abrade and split the earphone cord. Furthermore, when the headset plug is plugged into a receiver jack, an unexpected pull on the cord may pull the headset plug out of the receiver jack, which negatively affects an enjoyable headset experience.

Therefore, there is room for improvement within the art.

### BRIEF DESCRIPTION OF THE DRAWINGS

Many aspects of the disclosure can be better understood with reference to the following figures. The components in the figures are not necessarily drawn to scale, the emphasis instead being placed upon clearly illustrating the principles of the disclosure. Moreover, in the drawings, like reference numerals designate corresponding parts throughout the several views.

FIG. 1 is an exploded view of one embodiment of an earphone.

FIG. 2 is another exploded view of the earphone shown in FIG. 1.

FIG. 3 is an assembly view of the earphone shown in FIG. 1.

FIG. 4 is another assembly view of the earphone shown in FIG. 1.

### DETAILED DESCRIPTION

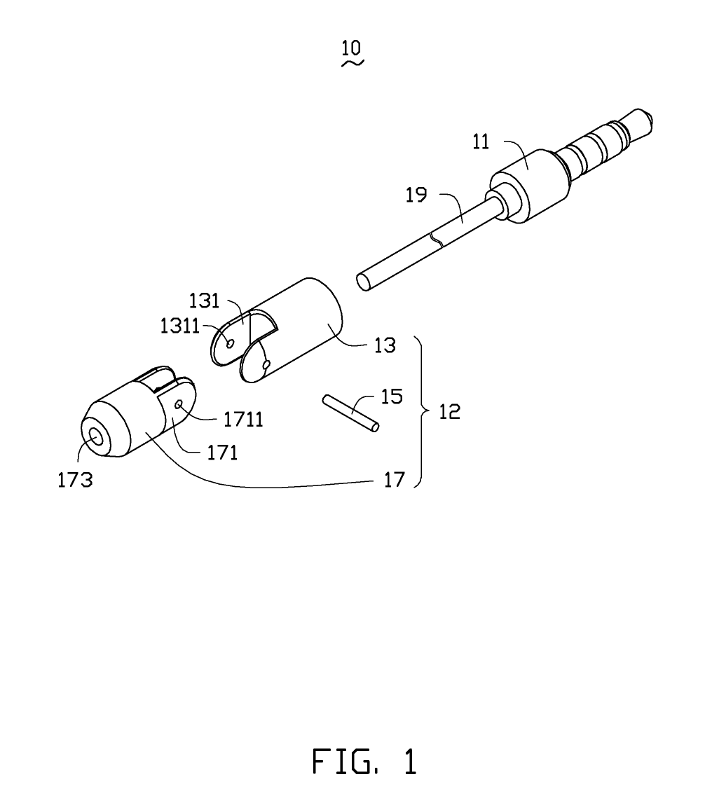

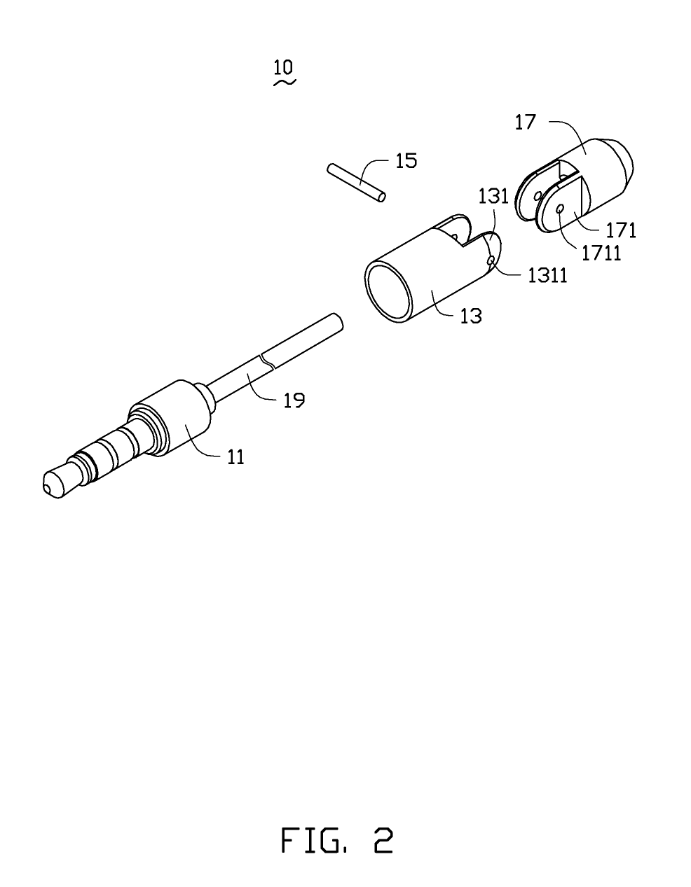

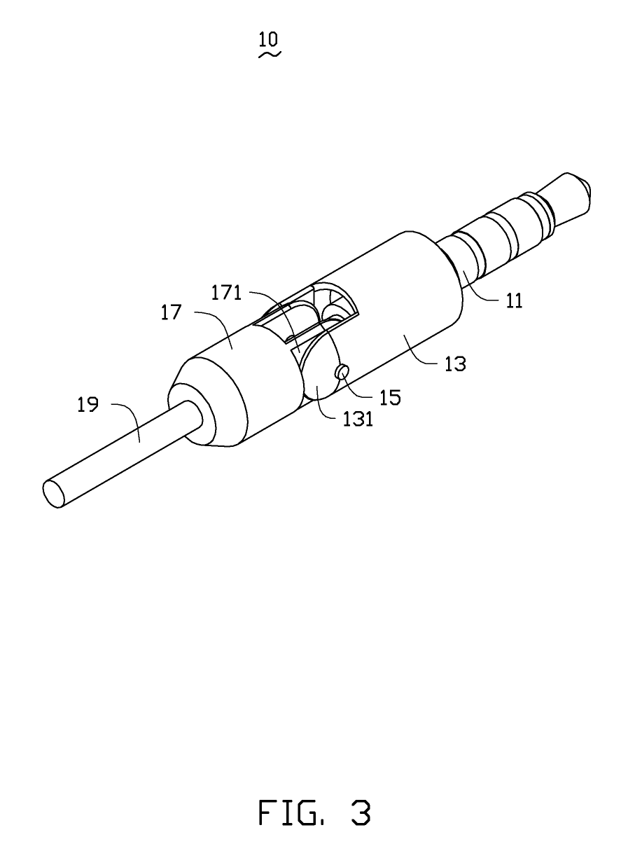

Referring to FIGS. 1, 2, and 3, an earphone 10 according to one exemplary embodiment includes an headset plug 11, an earphone cord 19 connecting to the headset plug 11, and a protector 12 located around the junction of the headset plug 11 and the earphone cord 19.

The protector 12 includes a fastening member 13, a shaft 15 mounted to the fastening member 13, and a rotary member 17 assembled to the fastening member 13 using shaft 15. The fastening member 13 is secured to the headset plug 11. The rotary member 17 is located around the earphone cord 19. The rotary member 17 can rotate in one plane relative to the fastening member 13 around the shaft 15 when the earphone cord 19 is bent.

In the exemplary embodiment, the fastening member 13 has a hollow cylindrical structure. One end of the fastening member 13 locates around and is secured to the headset plug 11. The shaft 15 is fixed to the other end of the fastening member 13. The fastening member 13 may be secured to the headset plug 11 using an adhesive such as seccotine glue. The fastening member 13 defines two parallel mounting walls 131 extending from the end of the fastening member 13 towards the earphone cord 19. Each mounting wall 131 defines a mounting through hole 1311. When the fastening member 13 is secured to the headset plug 11, each mounting wall 131 is located adjacent the earphone cord 19.

The rotary member 17 defines two assembling walls 171 extending from one end of the rotary member 17, towards the fastening member 13. Each assembling wall 171 defines an assembling through hole 1711. The two ends of the shaft 15 are mounted to the two mounting through holes 1311. The two ends of the shaft 15 are mounted to the two assembling through holes 1711. Accordingly, the rotary member 17 can rotate relative to the fastening member 13 around the shaft 15. In the exemplary embodiment, the shaft 15 is an interference fit to the mounting through holes 1311 to fix the shaft 15 to the fastening member 13.

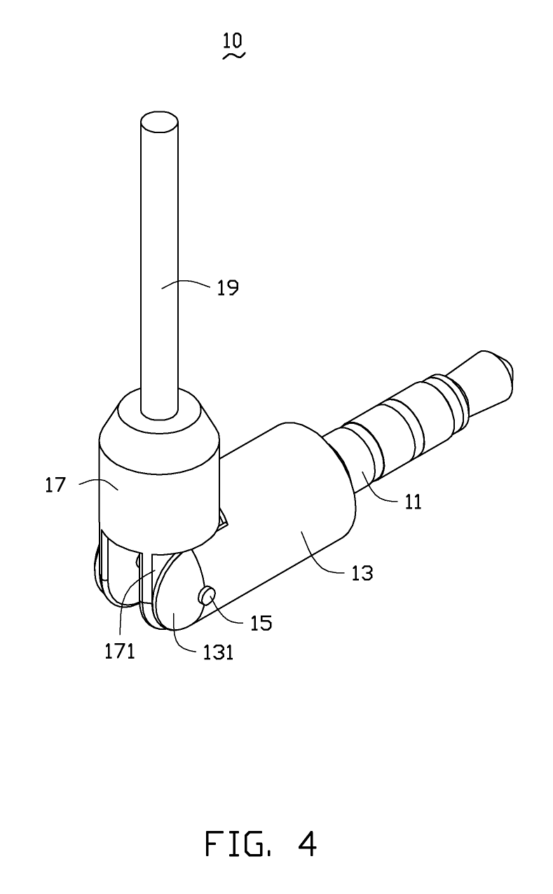

The rotary member 17 also defines a through hole 173 in the other end of the rotary member 17 (see FIG. 1). The earphone cord 19 passes through the through hole 173. Also referring to FIG. 4, when the earphone cord 19 is bent at the shaft 15 and relative to the headset plug 11, the rotary member 17 also rotates relative to the fastening member 13 around the shaft 15. That is, the rotary member 17 moves with the earphone cord 19, but the earphone cord 19 does not bend relative to the outer end of the rotary member 17. Thus, no friction or scratching occurs between the earphone cord 19 and the rotary member 17. When the earphone cord 19 is bent at the shaft 15, the bending is at an angle and curve small enough to not create strain issues. As such, the earphone cord 19 cannot be abraded or split.

In the exemplary embodiment, the fastening member 13 and the rotary member 17 may be both made of metal.

Referring to FIGS. 1, 2, and 3, when assembling the earphone 10, firstly the earphone cord 19 passes through the fastening member 13 and the through hole 173 of the rotary member 17. The fastening member 13 is then secured to the headset plug 11 using adhesive. The rotary member 17 and the fastening member 13 are brought together, allowing the assembling walls 171 to locate between the mounting walls 131, and the assembling through holes 1711 of the rotary member 17 aligned to the mounting through holes 1311. Then the shaft 15 is passed through the mounting through hole 1311, the assembling through hole 1711, the other mounting through hole 1311, and the other assembling through hole 1711 to attach the rotary member 17 to the fastening member 13. As such, the earphone 10 is assembled.

The exemplary protector 12 includes the rotary member 17 located around the earphone cord 19, and the rotary member 17 is assembled to the fastening member 13 by the shaft 15, allows the rotary member 17 to swing or pivot with the earphone cord 19 when the earphone cord 19 is bent towards the headset plug 11. That is, the earphone cord 19 does not bend relative to the rotary member 17, thus no friction or strain occurs between the earphone cord 19 and the rotary member 17. As such, the earphone cord 19 cannot be abraded or split. Furthermore, the rotary member 17 moving with the earphone cord 19 acts as an additional link against incidental pulls or drags, preventing the headset plug 11 from being pulled out of the receiver jack during an unexpected pull or drag on the earphone cord 19.

It is believed that the exemplary embodiment and its advantages will be understood from the foregoing description, and it will be apparent that various changes may be made thereto without departing from the spirit and scope of the disclosure or sacrificing all of its advantages, the examples hereinbefore described merely being preferred or exemplary embodiment of the disclosure.

What is claimed is:

1. A protector for an earphone cord located around a junction of the earphone cord and a headset plug, the protector comprising:
a fastening member secured to the headset plug, and
a rotary member being located around the earphone cord and rotatably assembled to the fastening member such that the rotary member rotates relative to the fastening member with the earphone cord when the earphone cord being bent.

2. The protector as claimed in claim 1, wherein the protector further comprises a shaft, the shaft is fixed to the fastening member, the rotary member is rotatably assembled to the shaft.

3. The protector as claimed in claim 2, wherein the fastening member defines two parallel mounting walls extending from one end of the fastening member, each mounting wall defines a mounting through hole, two ends of the shaft pass through and fix to the mounting through holes.

4. The protector as claimed in claim 3, wherein the shaft is interference fitted to the mounting through holes.

5. The protector as claimed in claim 3, wherein the rotary member defines two assembling walls extending parallel from one end of the rotary member and towards the fastening member, each assembling wall defines an assembling through hole, the shaft is rotatably mounted to the assembling through holes.

6. The protector as claimed in claim 1, wherein the fastening member is secured to the headset plug using an adhesive.

7. The protector as claimed in claim 6, wherein the adhesive is seccotine glue.

8. The protector as claimed in claim 1, wherein the fastening member and the rotary member are both made of metal.

9. An earphone, comprising:
a headset plug,
an earphone cord connecting to the headset plug; and
a protector located around the junction of the headset plug and the earphone cord, the protector comprising:
a fastening member secured to the headset plug, and
a rotary member being located around the earphone cord and rotatably assembled to the fastening member such that the rotary member rotates relative to the fastening member with the earphone cord when the earphone cord being bent.

10. The earphone as claimed in claim 9, wherein the protector further comprises a shaft, the shaft is fixed to the fastening member, the rotary member is rotatably assembled to the shaft.

11. The earphone as claimed in claim 10, wherein the fastening member defines two parallel mounting walls extending from one end of the fastening member, each mounting wall defines a mounting through hole, two ends of the shaft pass through and fix to the mounting through holes.

12. The earphone as claimed in claim 11, wherein the shaft is interference fitted to the mounting through holes.

13. The earphone as claimed in claim 11, wherein the rotary member defines two assembling walls extending parallel from one end of the rotary member and towards the fastening member, each assembling wall defines an assembling through hole, the shaft is rotatably mounted to the assembling through holes.

14. The earphone as claimed in claim 9, wherein the fastening member is secured to the headset plug using an adhesive.

15. The earphone as claimed in claim 14, wherein the adhesive is seccotine glue.

16. The earphone as claimed in claim 9, wherein the fastening member and the rotary member are both made of metal.
